(19) United States
(12) Patent Application Publication
(10) Pub. No.: US 2005/0156894 A1
(43) Pub. Date: Jul. 21, 2005

(54) Computer keyboard with a pointing device

(76) Inventors: Ruei-Hung Chen, Taichung Hsien (TW); Wen-Chin Hsieh, Taichung Hsien (TW); Wen-Kuei Liu, Taichung (TW)

Correspondence Address: Jackson Walker L.L.P., Suite 2100, 112 E. Pecan Street, San Antonio, TX, 78205, US

(21) Appl. No.: 10/974,193

(22) Filed: Oct. 27, 2004

(30) Foreign Application Priority Data
Dec. 24, 2003 (TW) 092222581

(51) Int. Cl. G09G 5/00

(52) U.S. Cl. 345/168

(57) ABSTRACT

A keyboard with a pointing device has a board with a bottom edge; a space key mounted on the bottom edge of the board, wherein the space key is particularly operated by either of two thumbs; multiple keys mounted on the board; and a pointing device mounted on the board and adjacent to the space key. By setting the pointing device adjacent to the space key, the pointing device can be conveniently driven by either thumb. Therefore, a user's hand does not need to move away from the keyboard when inputting data via the pointing device.

### BACKGROUND OF THE INVENTION

1. Field of the Invention

The present invention relates to a computer keyboard with a pointing device, and more particularly to a computer keyboard with a pointing device that is particularly adjacent to a space key to allow a user's thumb to independently and conveniently move the pointing device.

2. Description of Related Art

In a common computer device, a conventional keyboard and a conventional mouse are input devices for the computer device and both exist on a user's desk. However, the keyboard and the mouse are individual accessories, such that when the computer device is being operated, one hand has to constantly move between the keyboard and the mouse. Therefore, inputting data into the computer is time-consuming as the hand repeatedly moves the distance between the keyboard and the mouse. Moreover, the repeated movement of the hand will cause some occupational diseases such as muscle ache after operating the computer device for a period of time.

Additionally, when the hand movement between the keyboard and the mouse is great, the user's concentration is certainly interrupted because the user has to particularly search for location of the mouse or the correct position on the keyboard. Therefore, inputting data is not fluently carried out and inputting efficiency is limited.

Moreover, the mouse has to be moved on an area that occupies certain space on the user's desk. When the computer device is placed in a confined place, movement of the mouse is definitely limited.

The present invention has arisen to mitigate or obviate the disadvantages of the conventional keyboard and mouse.

### SUMMARY OF THE INVENTION

The main objective of the present invention is to provide a keyboard integrated with a pointing device that is easily operated by a thumb to increase inputting efficiency without a user's hands having to move away from the keyboard.

To achieve the foregoing objective, the keyboard with a pointing device of the present invention comprises:
a board with a bottom edge;
a space key mounted near the bottom edge on the board, wherein the space key is particularly operated by either of user's thumbs;
multiple keys mounted on the board; and
a pointing device mounted on the board and adjacent to the space key.

By setting the pointing device adjacent to the space key, the pointing device can be conveniently driven by either thumb. Therefore, a user's hands do not have to move away from the keyboard when inputting data.

Further benefits and advantages of the present invention will become apparent after a careful reading of the detailed description with appropriate reference to the accompanying drawings.

### BRIEF DESCRIPTION OF THE DRAWINGS

FIG. 1 is an operationally perspective view of a first embodiment of a keyboard with a pointing device in accordance with the present invention;

FIG. 2 is an operationally perspective view of a second embodiment of the keyboard with a pointing device in accordance with the present invention;

FIG. 3 is an operationally perspective view of a third embodiment of the keyboard with a pointing device in accordance with the present invention;

FIG. 4 is an operationally perspective view of the first embodiment of the keyboard with a pointing device that is a joy-stick ; and

FIG. 5 is an operational perspective view of a fourth embodiment of the keyboard with a pointing device in accordance with the present invention.

### DETAILED DESCRIPTION OF THE INVENTION

A keyboard with a pointing device in accordance with the present invention comprises: a board with a bottom edge; a space key mounted on the bottom edge of the board, wherein the space key is particularly operated by either thumb; multiple keys mounted on the board; and a pointing device mounted on the board and adjacent to the space key.

By setting the pointing device adjacent to the space key, the pointing device can be conveniently driven by the thumb. Therefore, a user's hands do not have to move away from the keyboard when inputting data and inputting efficiency is high.

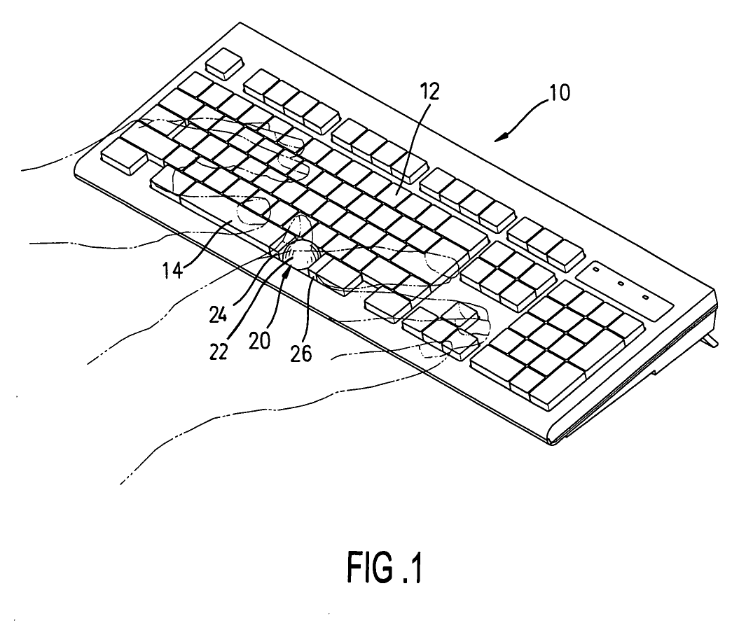

With reference to FIG. 1, a preferred embodiment of the keyboard with a pointing device in accordance with the present invention comprises a rectangular board (10) with a bottom edge, multiple keys (12) in groups of different functions, a space key (14) and a pointing device (20).

The space key (14) is mounted near the bottom edge on the board (10). The multiple keys (12) are respectively and conventionally classified into alphabet keys, number keys, cursor-moving keys and functional fast keys etc. Because these keys are well-known, redundant description about the keys is obviated here.

The pointing device (20) is mounted at a right side of the space key (14) and is composed of trackball (22), a left button (24) and a right button (26). Preferably, to keep the size of the keyboard consistent with conventional keyboards, the space key (14) is diminished at the right side to accommodate the pointing device (20) on the board (10). The right button (26) and the left button (24) are mounted on the board (10) beside the trackball (22) and have the same functions as found in a conventional mouse. Preferably, the trackball (22) has a height less then heights of the space key (14) and the multiple keys (12) on the board (10). The pointing device (20) is ideally suitable to be moved by the right thumb because the pointing device (20) is mounted at the right side of the space key (14). When the pointer is used to tow and select an area, the left button (24) is pressed by the left thumb and then the trackball (22) is simultaneously driven by the right thumb.

Because the pointing device (20) occupies an area at which a portion of the space key was originally located, the pointing device (20) is touched by the right thumb in a convenient way to drive the pointer without moving hands away from the keyboard. Therefore, the user is not interrupted when inputting data.

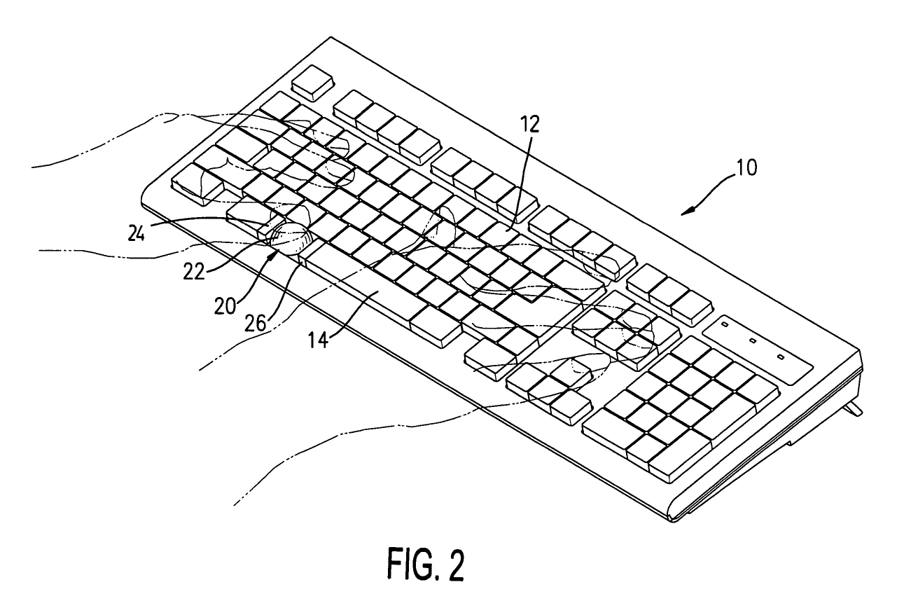

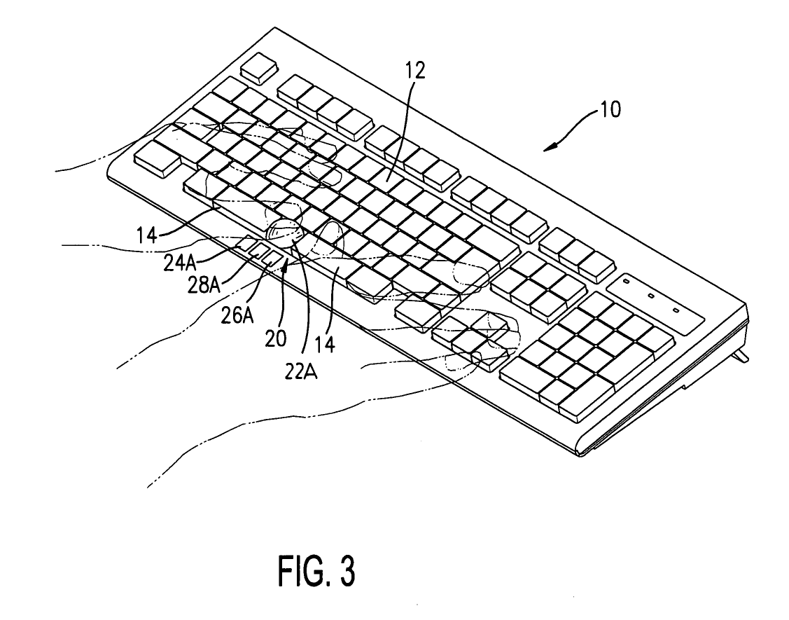

With reference to FIGS. 2 and 3, two more embodiments of the keyboard with a pointing device are shown in that each pointing device (20) is mounted at a different location. In these two embodiments, the pointing device (20) is selectively mounted at a left side of the space key (14) for left hander or at a middle location between two separated parts of the space key (14) for using the two hands alternatively. Moreover, as shown in FIG. 3, the pointing device (20) is composed of a trackball (22A), a right button (26A), a left button (24A) and a middle button (28A). The three buttons (26A, 24A, 28A) are attached below the trackball (22A) and the middle button (28A) is located between the right button (26A) and the left button (24A).

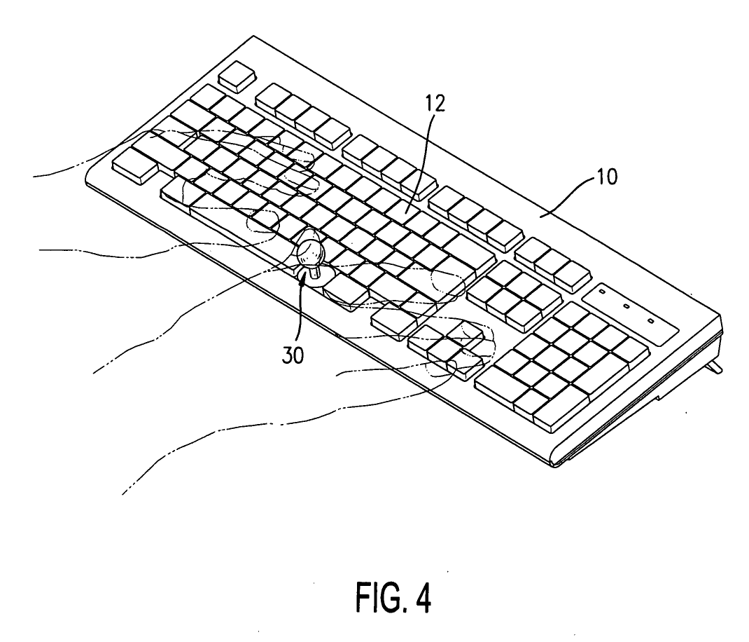

Furthermore, with reference to FIG. 4, the pointing device is a joy-stick (30). The joy-stick (30) is designed to have a two-stage pressing control for selecting or towing the pointer.

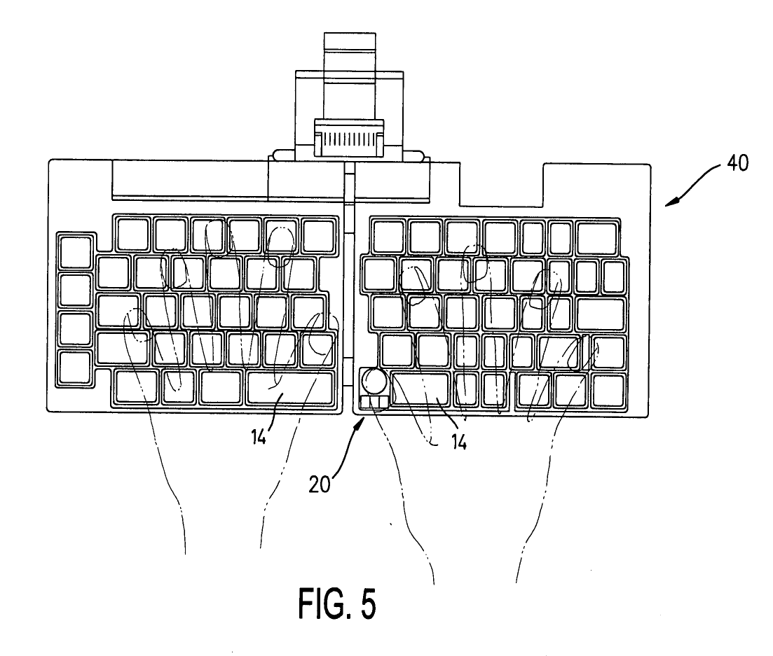

With reference to FIG. 5, the keyboard is a two-piece keyboard (40) composed of a right board and the left board and each having a bottom edge. The pointing device (20) is still mounted adjacent to the space key (14) near the bottom edge on the right board for convenient access by the right thumb.

According to the above description, the keyboard with a pointing device of the present invention has the following advantages:

1. In health: Because the pointing device is integrally mounted on the keyboard, a user's hands no longer need move between the separated conventional keyboard and the conventional pointing device, therefore, occupational harm of constantly moving the hands is obviated.

2. In operation and practicality: the pointing device is attached beside the space key so that pointing device can be driven by either thumb conveniently without disturbing other fingers when they press the keys on the keyboard. Therefore, interruption of hands inputting data by the user is eliminated and thus inputting efficiency is greatly increased.

3. In space-saving: the pointing device only takes a portion of the area originally required by the space key, therefore, the keyboard has minimal change. However, after incorporating the pointing device with the keyboard, the desk has more space due to the elimination of the non-integrated mouse of the prior art.

Although the invention has been explained in relation to its preferred embodiment, it is to be understood that many other possible modifications and variations can be made without departing from the spirit and scope of the invention as hereinafter claimed.

1. A keyboard with a pointing device comprising:
a board with a bottom edge;
a space key mounted on the bottom edge of the board, thereby the space key is particularly operated by either of two thumbs;
multiple keys mounted on the board; and
a pointing device mounted on the board and adjacent to the space key.

2. The keyboard as claimed in claim 1, wherein the space key has a right side and the pointing device is mounted at the right side of the space key.

3. The keyboard as claimed in claim 1, wherein the space key has a left side and the pointing device is mounted at the left side of the space key.

4. The keyboard as claimed in claim 1, wherein the space key is divided into two parts and the pointing device is located between the two parts of the space key.

5. The keyboard as claimed in claim 1, wherein the pointing device comprises a right button, a left button and a trackball rotatably mounted between the right button and the left button.

6. The keyboard as claimed in claim 1, wherein the pointing device comprises a right button, a left button and a trackball;
the right button and the left button are mounted on the board below the trackball.

7. The keyboard as claimed in claim 6, wherein the pointing device further comprises a middle button located between the right button and the left button.

8. The keyboard as claimed in claim 1, wherein the pointing device is a joy-stick.

9. The keyboard as claimed in claim 8, wherein the pointing device further comprises a right button and a left button mounted on the board below the joy-stick;
the pointing device further comprises a middle button located between the right button and the left button.
